(19) United States
(12) Patent Application Publication
(10) Pub. No.: US 2014/0265052 A1
(43) Pub. Date: Sep. 18, 2014

(54) BLOW MOLDING DEVICE AND BLOW MOLDING METHOD

(71) Applicant: FTS CO., LTD., Aichi Prefecture (JP)

(72) Inventors: Takahisa MAJIMA, Aichi Prefecture (JP); Toshiaki Asahara, Aichi Prefecture (JP); Koji Sugiura, Aichi Prefecture (JP)

(73) Assignee: FTS CO., LTD., Aichi Prefecture (JP)

(21) Appl. No.: 13/846,693

(22) Filed: Mar. 18, 2013

(51) Int. Cl. B29C 49/20

(52) U.S. Cl. CPC B29C 49/20
USPC 264/516; 425/503

(57) ABSTRACT

A blow molding device capable of forming a blow molded article having a built-in part with a good yield rate, and a blow molding method. The blow molding device has a blow mold, a parison holding unit and a built-in part holding unit. The parison holding unit has parison expanders and a parison outer holding plate. The built-in part holding unit has an airtight guide tube and a holding rod. After a lower end of a parison is expanded with a plurality of parison expanders, and an upper end of the airtight guide tube is inserted in the lower end of the parison, the lower end of the parison is held between the upper end of the airtight guide tube and the parison outer holding plate, and the preblowing is carried out. After the built-in part is positioned in an interior space of the parison, and the parison and built-in part are held with the slide cores, the holding rod is removed from the blow mold.

### CROSS-REFERENCE TO RELATED APPLICATION

This application is related to and claims priority from Japanese patent application No. 2011-210979 incorporated herein by reference.

### BACKGROUND OF THE INVENTION

1. Field of the Invention

The present invention relates to a blow molding device adapted to form a blow molded article having a built-in part composed of a thermoplastic synthetic resin in an interior space thereof, and a blow molding method.

2. Description of Related Art

Conventionally, tubular blow molded articles, such as fuel tanks for use in motor vehicles, etc., have been formed of metal, but, in recent years, thermoplastic synthetic resins have been frequently used to form such tubular blow molded articles, because they can effect lightweight vehicle bodies, no rust is generated therein, and they can be readily formed into desired configurations.

In many cases, the tubular articles made of thermoplastic synthetic resins have been formed by blow molding, because tubular bodies can be readily formed therewith. Upon blow molding, a parison of a molten thermoplastic synthetic resin is extruded downwardly into a cylindrical configuration, and air is blown into the parison with the parison held with the mold, thereby forming the tubular bodies.

On the other hand, upon blow molding, built-in parts such as valves, baffle plates adapted to restrain noise caused by the flowing of fuel, etc. may be required to be provided in an interior space of the blow molded article, such as the fuel tank.

Conventionally, in order to provide the built-in parts in the interior space of the blow molded article, a molding device shown in FIG. 1 has been used (see published Japanese patent applications No. Hei 9-174670 and Hei 8-72129, for example.). A built-in part 10 is held in a cavity of a blow mold 12 with a holding rod 14, and a parison 16 is lowered. Then, the blow mold 12 is closed, and the parison 16 is pinched with pinching plates 18 to form the blow molded article.

When the dimensions of a built-in part increase, as shown in FIG. 2, a built-in part 20 held with a holding rod 22 is inserted in the interior space of the parison 16 while supporting the built-in part 20 with slide cores 24 that are provided in a blow mold 26. Upon inserting of the built-in part 20, it is necessary to prevent the built-in part 20 from contacting an inner wall of the parison 16.

To this effect, the diameter of the parison 16 must be increased. But, when the diameter of the parison 16 increases, the parison 16 is extruded exceeding a required amount for forming the blow molded article, and as a result, the amount of flash around the resulted blow molded article increases to cause a waste of material. In addition, die cores adapted to extruded the parison 16 become large, and the number thereof increases.

### SUMMARY OF THE INVENTION

Accordingly, it is an object of the present invention to provide a blow molding device and a blow molding method capable of forming a blow molded article having a built-in part with a good yield rate.

According to a first aspect of the present invention, in a blow molding device for forming a blow molded article having a built-in part in an interior space thereof, the blow molding device includes a blow mold adapted to form an outer wall of the blow molded article, a parison holding unit adapted to hold a lower end of a parison; and a built-in part holding unit adapted to hold the built-in part prior to blow molding.

The blow mold has two mold members split along a parting line thereof, the two mold members define a cavity adapted to form the blow molded article in split faces thereof, slide cores are provided in an inner surface of the blow mold so as to be slid inwardly and outwardly of the cavity such that the built-in part and the parison are held between the slide cores, whereby the outer wall of the blow molded article is molded within the cavity.

The parison holding unit adapted to hold a lower end of the parison is located on the lower side of the blow mold, and includes a plurality of parison expanders adapted to be inserted in an interior space of a lower end of the parison, and a parison outer holding plate adapted to hold an outer surface of the lower end of the parison, each of the parison expanders is attached so as to slide outwardly from a center of the parison.

And the built-in part holding unit includes an airtight guide tube adapted to hold the built-in part therein, a holding rod adapted to hold the built-in part in the airtight guide tube so as to slide the built-in part upwardly and downwardly, and a lower guide plate having a hole through which the holding rod is slidable.

The blow molding device is arranged such that when the blow mold is opened, the lower end of the parison located in the cavity of the blow mold that is opened is expanded with the plurality of parison expanders, after the airtight guide tube is inserted in the lower end of the parison, the lower end of the parison is held between the airtight guide tube and the parison outer holding plate, the parison is inflated to carry out preblowing, then, the built-in part is slid from the airtight guide tube to the interior space of the parison with the holding rod so as to hold the built-in part in the parison so as to face the cavity, then, when the blow mold is closed, the built-in part is positioned in the interior space of the parison, and after the parison and the built-in part are held between the slide cores, the holding rod is removed from the blow mold.

With the first aspect of the present invention, the blow molding device has a blow mold adapted to form an outer wall of the blow molded article, a parison holding unit adapted to hold a lower end of a parison, and a built-in part holding unit adapted to hold the built-in part prior to blow molding. With this arrangement, by holding the lower end of the parison, expanding the same and inserting the built-in part within the parison prior to blow molding, the blow molded article having the built-in part therein can be obtained.

The blow mold has two mold members split along a parting line thereof, two split mold members define a cavity adapted to form the outer wall of the blow molded article in split faces thereof, and slide cores are provided in an inner surface of the blow mold so as to be slid inwardly and outwardly of the cavity such that the built-in part and the parison are held between the slide cores, whereby the outer wall of the blow molded article is molded within the cavity. Therefore, by holding the built-in part within the parison with the slide cores, the blow molded article having the built-in part in position can be formed within the cavity.

The parison holding unit adapted to hold a lower end of the parison is located on the lower side of the blow mold, and includes a plurality of parison expanders adapted to be inserted in an interior space of a lower end of the parison, and a parison outer holding plate adapted to hold an outer surface of the lower end of the parison, each of the parison expanders is attached so as to slide outwardly from a center of the parison. Therefore, the lower end of the parison can be expanded and opened with the parison expanders, the airtight guide tube can be inserted in the lower end of the parison so that when the parison is inflated by preblowing, and the built-in part is inserted within the parison, the built-in part can be prevented from contacting the inner surface of the parison.

The built-in part holding unit has an airtight guide tube adapted to hold the built-in part therein, a holding rod adapted to hold the built-in part in the airtight guide tube so as to slide the built-in part upwardly and downwardly, and a lower guide plate having a hole through which the holding rod is slidable.

Therefore, the airtight guide tube can hold the built-in part therein so as to be slid upwardly and downwardly, and seal the airtight guide tube.

In addition, the built-in part may be held within the airtight guide tube so that built-in parts having various different dimensions can be used. In addition, by determining the waiting position of the built-in part prior to inserting thereof in the airtight guide tube, the specifications of the built-in part can be readily changed.

After the blow mold is opened, the lower end of the parison located in the cavity of the blow mold that is opened is expanded with the plurality of parison expanders. Therefore, the lower end of the parison can be enlarged so that it is unnecessary to enlarge the outside diameter of the parison for inserting the built-in part therein, and consequently, the amount of materials for the parison can be saved.

After the airtight guide tube is inserted in the lower end of the parison, the lower end of the parison is held between the airtight guide tube and the parison outer holding plate, and the parison is inflated to carry out preblowing. Therefore, the built-in part is moved from the airtight guide tube to an interior space of the parison with the holding rod so as to hold the built-in part in a position facing the cavity. With this arrangement, the outside diameter of the parison is inflated, the built-in part can be located in a predetermined position of the cavity of the blow mold with the holding rod without contacting the inner surface of the parison.

The holding rod is slidably arranged such that when the blow mold is closed, the built-in part is positioned in the interior space of the parison, and after the parison and the built-in part are held between the slide cores, the holding rod is removed from the blow mold. Therefore, blow molding can be carried out with the built-in part held in position of the cavity, the blow molded article having the built-in part in position can be obtained.

According to a second aspect of the present invention, the blow molding device further has preblow injection ports at upper ends of the parison expanders so as to inject gas when an upper end of the airtight guide tube and the parison outer holding plate hold the lower end of the parison.

With the arrangement of the second aspect of the present invention, preblow injection ports are provided at upper ends of the parison expanders so as to inject gas when an upper end of the airtight guide tube and the parison outer holding plate hold the lower end of the parison. Therefore, gas is injected from the preblow injection ports provided at upper ends of the parison expanders to inflate the parison by preblowing with the lower end of the parison held with the upper end of the airtight guide tube and the parison outer holding plate so that the built-in part can be readily inserted in the interior space of the parison.

According to a third aspect of the present invention, the parison expanders are arranged so as to contact the upper end of the airtight guide tube with a slide mechanism, and recesses adapted to accommodate ends of the parison expanders are formed in an upper end of the airtight guide tube.

With the arrangement of the third aspect of the present invention, the parison expanders are arranged so as to contact the upper end of the airtight guide tube with a slide mechanism, and recesses adapted to accommodate ends of the parison expanders are formed in an upper end of the airtight guide tube. Therefore, when the parison outer holding plate holds the periphery of the lower end of the parison, the parison expanders become integral with the airtight guide tube in an outer surface thereof, thereby holding the parison while maintaining the airtight condition of the interior space thereof.

According to a fourth aspect of the present invention, the blow molding device further includes an upper pinching plate adapted to pinch an upper end of the parison on the upper side of the blow mold away therefrom.

With the arrangement of the fourth aspect, the blow molding device further includes an upper pinching plate adapted to pinch an upper end of the parison on the upper side of the blow mold away therefrom. Therefore, upon premolding, the airtight condition of the upper end of the parison can be maintained, and upon inserting of the built-in part, the inflated condition of the parison can be maintained.

According to a fifth aspect of the present invention, the parison outer holding plate is split into two split plates so as to be respectively moved by a cylinder toward an end face of the airtight guide tube to contact the same.

With the arrangement of the fifth aspect of the present invention, the parison outer holding plate is split into two split plates so as to be respectively moved by a cylinder toward an end face of the airtight guide tube to contact the same. Therefore, the lower end of the parison can be securely held between the parison outer holding plate and the airtight guide tube in the airtight condition.

According to a sixth aspect of the present invention, in a blow molding method for forming a blow molded article having a built-in part in an interior space thereof, the blow molding method uses a blow mold adapted to form an outer wall of the blow molded article, a parison holding unit adapted to hold a lower end of a parison, and a built-in part holding unit adapted to hold the built-in part prior to blow molding.

The blow mold includes two mold members split along a parting line thereof and defining a cavity adapted to form the blow molded article in split faces thereof, and slide cores are provided in an inner surface of the blow mold so as to be slid outwardly and inwardly of the cavity.

The parison holding unit includes a plurality of parison expanders adapted to be inserted in an interior space of a lower end of the parison, and a parison outer holding plate adapted to hold an outer surface of the lower end of the parison, each of the parison expanders is attached so as to slide outwardly from a center of the parison.

The built-in part holding unit includes an airtight guide tube adapted to hold the built-in part therein, a holding rod adapted to hold the built-in part in the airtight guide tube so as to slide the built-in part upwardly and downwardly, and a lower guide plate having a hole through which the holding rod is slidable.

In the blow molding method, the blow mold is opened along the parting line, the parison is dropped in the cavity that is opened, and the lower end of the parison is expanded with the plurality of parison expanders, then, the airtight guide tube is inserted in the lower end of the parison to hold the lower end of the parison between the airtight guide tube and the parison outer holding plate, gas is injected in an interior space of the parison to inflate the same to carry out preblowing, then, the built-in part is positioned in the interior space of the parison from the airtight guide tube with the built-in part held with the holding rod, and is held in a position facing the cavity, then, the blow mold is closed to hold the parison and the built-in part between the slide cores, the holding rod is removed from the blow mold, and after the blow mold is closed completely, gas is blown in the interior space of the parison to form the blow molded article.

With the arrangement of the sixth aspect of the present invention, the blow molding method uses a blow mold adapted to form an outer wall of the blow molded article, a parison holding unit adapted to hold a lower end of a parison, and a built-in part holding unit adapted to hold the built-in part prior to blow molding. Therefore, by holding the lower end of the parison, inserting the built-in part in the parison, and enlarging the lower end of the parison prior to blow molding, the blow molded article having a built-in part in an interior space thereof can be obtained.

The blow mold includes two mold members split along a parting line thereof defining a cavity adapted to form the blow molded article in split faces thereof, and slide cores are provided in an inner surface of the blow mold so as to be slid inwardly and outwardly of the cavity. Therefore, by holding the built-in part with the slide cores in the parison, the blow molded article having a built-in part in a predetermined position of an interior space thereof can be formed in the cavity.

The parison holding unit includes a plurality of parison expanders adapted to be inserted in an interior space of a lower end of the parison, and a parison outer holding plate adapted to hold an outer surface of the lower end of the parison. The parison expanders are attached so as to be slid transversely relative to the parison. Therefore, the lower end of the parison can be opened with the parison expanders, and the airtight guide tube can be securely inserted in the lower end of the parison, whereby when preblowing is carried out to inflate the parison, and the built-in part is inserted into the parison, the built-in part can be prevented from contacting an inner wall of the parison.

The built-in part holding unit includes an airtight guide tube adapted to hold the built-in part therein, a holding rod adapted to hold the built-in part in the airtight guide tube so as to slide the built-in part upwardly and downwardly, and a lower guide plate having a hole through which the holding rod is slidable, and closing the lower end of the airtight guide tube. Therefore, the airtight guide tube can hold the built-in part slidably in an interior space thereof, and seal the airtight guide tube.

And the built-in part may be held in an interior space of the airtight guide tube so that built-in parts of various dimensions can be used. In addition, by determining the waiting position of the built-in part prior to inserting thereof in the airtight guide tube, the specifications of the built-in part can be readily modified.

After the blow mold is opened along the parting line, the parison is dropped in the cavity that is opened, and the lower end of the parison is expanded with a plurality of parison expanders, the airtight guide tube is inserted in the lower end of the parison. Therefore, the lower end of the parison can be expanded so that it is unnecessary to enlarge the outside diameter of the parison for inserting the built-in part, whereby the amount of the parison can be reduced.

After the lower end of the parison is held between the airtight guide tube and the parison outer holding plate, and gas is inserted in the interior space of the parison to inflate the same to carry out preblowing, the built-in part is positioned in an interior space of the parison from the airtight guide tube with the built-in part held with the holding rod. As a result, the outside diameter of the parison is inflated so that when the built-in part is inserted, it can be positioned in a predetermined position of the cavity with the holding rod without contacting the inner wall of the parison.

When the blow mold is closed with the built-in part held in the position facing the cavity, the built-in part is positioned in the interior space of the parison, after the parison and the built-in part are held with the slide cores, the holding rod is removed from the blow mold, and after the blow mold is closed completely, gas is blown in the interior space of the parison to form a blow molded article. Therefore, the blow molded article having the built-in part positioned in a predetermined position can be obtained without coming off in the interior space of the parison. After that, the blow molded article can be removed from the cavity by opening the blow mold.

According to a seventh aspect of the present invention, gas is injected from preblow injection ports provided at upper ends of the parison expanders to carry out preblowing after an upper end of the airtight guide tube and the parison outer holding plate hold the lower end of the parison.

With the arrangement of the seventh aspect of the present invention, gas is injected from preblow injection ports provided at upper ends of the parison expanders to carry out preblowing after an upper end of the airtight guide tube and the parison outer holding plate hold the lower end of the parison. Therefore, the parison can be inflated by preblowing with the lower end of the parison held between the upper end of the airtight guide tube and the parison outer holding plate, thereby facilitating the inserting of the built-in part within the parison.

According to an eighth aspect of the present invention, recesses adapted to accommodate ends of the parison expanders are formed in an upper end of the airtight guide tube, and after the parison expanders are accommodated in the recesses of the airtight guide tube with a slide mechanism, the upper end of the airtight guide tube and the parison expanders contact an inner surface of the parison, whereas the outer holding plate contacts an outer surface of the parison, thereby holding the lower end of the parison.

With the arrangement of the eighth aspect of the present invention, recesses adapted to accommodate ends of the parison expanders are formed in an upper end of the airtight guide tube, and after the parison expanders are accommodated in the recesses of the airtight guide tube with a slide mechanism, the upper end of the airtight guide tube and the parison expanders contact an inner surface of the parison, whereas the outer holding plate contacts an outer surface of the parison, thereby holding the lower end of the parison. Therefore, the parison expander becomes integral with the airtight guide tube and contacts the inner surface of the parison to seal against the parison, whereas the parison outer holding plate contacts an outer surface of the parison to hold the lower end of the parison.

According to a ninth aspect of the present invention, an upper end of the parison is pinched with an upper pinching plate provided on the upper side of the blow mold away therefrom prior to preblowing.

With the arrangement of the ninth aspect of the present invention, an upper end of the parison is pinched with an upper pinching plate provided on the upper side of the blow mold away therefrom prior to preblowing. Therefore, upon preblowing, the upper end of the parison can be held in the airtight condition, and upon inserting of the built-in part, the parison can be kept in the inflated condition.

According to a tenth aspect of the present invention, the parison outer holding plate is split into two split plates so as to be respectively moved by a cylinder toward an end face of the airtight guide tube to contact the same.

With the tenth aspect of the present invention, the parison outer holding plate is split into two split plates so as to be respectively moved by a cylinder toward an end face of the airtight guide tube to contact the same. Therefore, the lower end of the parison can be held between the parison outer holding plate and the airtight guide tube in the airtight condition.

In accordance with the present invention, the built-in part holding unit includes an airtight guide tube, a holding rod and a lower guide plate so that the airtight guide tube can hold a built-in part in an interior space thereof so as to be slid therein, and preblowing can be carried out by sealing the airtight guide tube.

The lower end of the parison is held between the upper end of the airtight guide tube and the parison outer holding plate, and when the parison is inflated and the built-in part is inserted in the inflated parison, the built-in part can be located in a predetermined position of the cavity with the holding rod without contacting the inner surface of the parison. When the parison is extruded, the outside diameter of the parison is not required to increase so as to reduce the amount of the material for the parison.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a perspective view of a conventional blow molding device adapted to form a blow molded article;

FIG. 2 is a sectional view of another conventional blow molding device, which shows a state in which a parison enters an interior space of a blow mold;

FIG. 3 is a perspective view of a fuel tank formed by an embodiment of a blow molding device in accordance with the present invention;

FIG. 4 is a top view of a parison holding unit and a built-in part holding unit in an embodiment of a blow molding device in accordance with the present invention;

FIG. 5 is a sectional view showing a process of forming a blow molded article with an embodiment of a blow molding device of the present invention, and showing a state in which a parison enters an interior space of a blow mold;

FIG. 6 is a sectional view showing a process of forming a blow molded article with an embodiment of a blow molding device of the present invention, and showing a state in which a lower end of a parison is enlarged with parison expanders;

FIG. 7 is a sectional view showing a process of forming a blow molded article with an embodiment of a blow molding device of the present invention, and showing a state in which a lower end of a parison is held between a parison outer holding plate and an upper end of an airtight guide tube;

FIG. 8 is a sectional view showing a process of forming a blow molded article with an embodiment of a blow molding device of the present invention, and showing a state in which a preblowing process is carried out with a lower end of a parison held between a parison outer holding plate and an upper end of an airtight guide tube;

FIG. 9 is a schematic perspective view showing a state in which a parison is held between a parison holding unit and an upper part of a built-in part holding unit in an embodiment of a blow molding device of the present invention;

FIG. 10 is an enlarged schematic perspective view showing upper ends of parison expanders in a state in which a parison is held between a parison holding unit and an upper part of a built-in part holding unit in an embodiment of a blow molding device of the present invention;

FIG. 11 is a sectional view showing a process of forming a blow molded article with an embodiment of a blow molding device of the present invention, and showing a state in which a built-in part is inserted in an interior space of a parison from a lower end of the parison;

FIG. 12 is a sectional view showing a process of forming a blow molded article with an embodiment of a blow molding device of the present invention, and showing a state in which a built-in part inserted in an interior space of a parison is held between slide cores;

FIG. 13 is a sectional view showing a process of forming a blow molded article with an embodiment of a blow molding device of the present invention, and showing a state in which a built-in part holding rod is removed from a blow mold with a built-in part inserted in an interior space of a parison held between slide cores;

FIG. 14 is a sectional view showing a process of forming a blow molded article with an embodiment of a blow molding device of the present invention, and showing a state in which a blow molding process is carried out with a built-in part held between slide cores in an interior space of a parison, and a blow mold closed.

### DETAILED DESCRIPTION OF THE PREFERRED EMBODIMENTS

Hereinafter, an embodiment of a blow molding device of the present invention will be explained based on a blow molding device adapted to form a fuel tank for use in a motor vehicle, as a blow molded article with reference to FIG. 3 through FIG. 14. The present invention will be explained with reference to the blow molding device for forming a fuel tank having a built-in part, but can be applied to another blow molded article having another built-in part.

FIG. 3 is a perspective view of a fuel tank 30 that is formed using a blow molding device of the present embodiment.

As shown in FIG. 3, the fuel tank 30 formed with the blow molding device of the present embodiment has a pump unit mounting hole 32 for mounting a fuel pump (not shown) on the fuel tank 30 in an upper surface thereof. And, a fuel inlet hole 34 is provided in a side surface or the upper surface of the fuel tank 30 for injecting fuel from an inlet pipe (not shown).

And, an outer circumferential rib 36 is provided around the fuel tank 30 over an entire length thereof, and a plurality of tank mounting holes 38 are formed in the outer circumferential rib 36 in predetermined positions such as corners, etc. thereof. By bolting the tank mounting holes 38 and a vehicle body together, the fuel tank 30 is mounted on the vehicle body.

In addition, mounting holes 40 are provided in the upper surface of the fuel tank 30 for connecting hoses, etc. adapted to collect evaporated fuel from an interior space of the tank, etc. thereto.

The fuel tank 30 is formed using a blow molding device of the present embodiment. An outer wall of the fuel tank 30 is formed by blow molding into a single layer or multiple layers. In the case of the multiple layers, the outer wall includes a skin layer, an exterior main layer, an exterior adhesive layer, a barrier layer, an interior adhesive layer and an interior main layer.

A built-in part 42 such as a pillar member adapted to reinforce the fuel tank 30, a baffle plate adapted to prevent occurrences of waving of fuel, and consequently, prevent occurrences of waving noise, a box adapted to mount fuel pumps, canisters, etc. is mounted in an interior space of the fuel tank 30.

The built-in part 42 can be composed of a thermoplastic synthetic resin exhibiting a fuel oil resistance, such as polyacetal, high-density polyethylene (HDPE), etc. With this arrangement, the strength of the fuel tank 30 can be improved, and the rigidity of the fuel tank 30 is not reduced due to swelling by fuel oil, etc. even if the built-in part 42 is attached in the interior space of the fuel tank 30.

The blow molding device of the first embodiment and the method for forming the blow molded fuel tank 30 using the blow molding device will be explained with reference to FIGS. 4 through 14. The blow molding device has a blow mold 44 adapted to mold a blow molded article, a parison holding unit 46 adapted to hold a lower end of the parison 16 and a built-in part holding unit 48 adapted to hold the built-in part 42 in an interior space of an airtight guide tube, and insert the same in an interior space of the parison 16 within the blow mold 44.

First, the parison holding unit 46 will be explained with reference to FIGS. 4, 6 and 8.

The parison holding unit 46 adapted to hold the lower end of the parison 16 is provided on the lower side of the blow mold 42, and the parison holding unit 46 has a parison expander 50 adapted to be inserted in an interior space of the lower end of the parison 16, which projects from a lower end of the blow mold 42, and a parison outer holding plate 52 adapted to hold an outer surface of the lower end of the parison 16.

A plurality of parison expanders 50 are provided so as to expand the lower end of the parison 16. In the present embodiment, four parison expanders 50 are provided so as to face four corners of a later-described airtight guide tube 54. When the parison expanders 50 contact the airtight guide tube 54, they are accommodated in recesses 56 provided in the airtight guide tube 54 to become integral therewith, and consequently, define outer surfaces flush with the outer surface of the airtight guide tube 54, thereby holding an inner surface of the parison 16 in an airtight condition.

The parison expanders 50 are attached so as to be movable radially outwardly, namely in directions perpendicular to the parison 16, with parison cylinders 58. And the parison expanders 50 contact an inner surface of the lower end of the parison 16. By moving the parison tubes 58 backwardly, the inside diameter of the parison 16 can be enlarged.

The parison expanders 50 can continuously expand the lower end of the parison 16 so as not to be crushed. When an upper end of the airtight guide tube 54 is inserted in the interior space of the parison 16, the inner surface of the parison 16 is enlarged so as to contact the outer surface of the upper end of the airtight guide tube 54

As shown in FIG. 10, preblow outlet ports 64 are provided at ends of the parison expanders 50 for injecting gas such as air in the interior space of the parison 16.

The parison outer holding plate 52 has a recess 62 conforming to the configuration of an outer periphery of the airtight guide tube 54 and an outer periphery of the parison expander 50. With this arrangement, the lower end of the parison 16 can be held with the parison expander 50, the airtight guide cylinder 54 and the parison outer holding plate 52. The parison outer holding plate 52 is formed so as to be split into a plurality of plates, each being formed so as to slide for holding the lower end of the parison 16, respectively. In the present embodiment, the parison outer holding plate 52 is formed so as to be split into two plates. Alternatively, it may be formed so as to be split into three or more plates.

When the parison outer holding plate 52 is slid towards the airtight guide tube 54 (towards a center of the parison 16), the outer periphery of the lower end of the parison 16 is pressed to securely hold the parison 16 with the upper end of the airtight guide tube 54, the parison expander 50 and the parison outer holding plate 52. As a result, gas can be prevented from leaking therebetween so that the lower end of the parison 16 can be prevented from being crushed. In addition, the volume of the interior space of the parison 16 can be maintained large so that a sufficient amount of gas can be airtightly enclosed therein. Therefore, the preblowing process for slightly inflating the parison 16 can be carried out prior to the blowing process for bringing the parison 16 into close contact with the mold.

Next, the built-in part holding unit 48 will be explained with reference to FIG. 4 and FIG. 8. The built-in part holding unit 48 has the airtight guide tube 54 and a built-in part holding rod 66 adapted to hold the built-in part 42 in an interior space of the airtight guide tube 54 and move upwardly and downwardly so as to insert the built-in part 42 in the parison 16, and a lower guide plate 68 adapted to close a lower end of the airtight guide tube 54.

The airtight guide tube 54 has a tubular configuration, and accommodates and holds the built-in part 42 in an interior space thereof so as to move the same upwardly and downwardly. The airtight guide tube 54 may have a circular, elliptical or polygonal cross-sectional shape so as to accommodate the built-in part 42. The tubular wall of the airtight guide tube 54 can be formed into a bellow-like configuration.

The built-in part holding rod 66 can hold the built-in part 42 in the interior space of the airtight guide tube 54 so as to move the same upwardly and downwardly. When the lower end of the parison 16 is held with the upper end of the airtight guide tube 54, it can be made airtight.

The built-in part 42 may be held in the interior space of the airtight guide tube 54 so that the airtight guide tube 54 can be applied to built-in parts having various dimensions By determining the waiting position of the built-in part 42 prior to inserting process in the airtight guide tube 54, the specification of the built-in part 42 can be readily varied.

The lower guide plate 68 has a guide hole 71 so as to slide the built-in part holding rod 66 therethrough. The lower guide plate 68 slides within the airtight guide tube 54 in accordance with the sliding of the built-in part holding rod 66 while sealing the interior of the airtight guide tube 54. A plurality of built-in part holding rods can be provided in accordance with the dimensions of the built-in part 42. The lower guide plate 68 may be attached to the built-in part holding rod 66 so as to be raised and lowered within the airtight guide tube 54 in accordance with the sliding of the built-in part holding rod 66.

As described above, the airtight guide tube 54 has recesses 56 for accommodating the parison expanders 50.

Next, the blow mold 44 will be explained with reference to FIG. 5.

The blow mold 44 is split along a parting line to provide two mold members, and the two mold members are slid leftward and rightward with a blow mold moving unit (not shown), thereby opening the blow mold 44. The blow mold 44 defines a cavity 60 adapted to mold the fuel tank 30 in an interior thereof. In addition, slide cores 70 are slidably provided in the two mold members of the blow mold 44 so as to face the cavity 60.

When the blow mold 44 is closed and the slide cores 70 are retreated, they partly define an inner surface defining the cavity 60, and when the blow mold 44 is opened and the slide cores 70 advance into the cavity 60, they hold the built-in part 42 and the parison 16. The parison 16 is extruded downwardly from a nozzle (not shown) provided on the upper side of the blow mold 44.

When the blow mold 44 is closed, the two mold members of the blow mold 44 contact each other around the cavity 60. In FIG. 14, they contact each other in upper mating faces 72 of the blow mold 44 and lower mating faces 76 thereof.

Next, the method for forming a fuel tank 30 for use in a motor vehicle, as a blow molded article using the blow molding device in accordance with the present invention will be explained with reference to FIGS. 5 through 14.

An upper pinching plate 80 is provided above the blow mold 44. And, as shown in FIGS. 6 through 14, the parison holding unit 46 is attached on the lower side of the blow mold 44.

In the blow molding process, as shown in FIG. 5, first, the blow mold 44 is opened to open the cavity 60 thereof, and the parison 16 is extruded from a nozzle (not shown) therein. And the lower end of the parison 16 reaches downwardly of a lower end 78 of the blow mold 44.

Next, as shown in FIG. 6, the parison expanders 50 enter the interior space of the parison 16 and contact the inner surface thereof. Then, as shown by arrows therein, the parison expanders 50 are moved in directions away from the center of the parison 16 to enlarge the lower end of the parison 16.

At this time, the built-in part holding unit 48 holding the built-in part 42 therewithin is located below the lower end of the parison 16.

Next, as shown in FIG. 7, the upper pinching plate 80 is closed to close an upper end of the parison 16.

Then, the airtight guide tube 54 is inserted in the interior space of the parison 16. And, the parison expanders 50 contact the upper end of the airtight guide tube 54, and are accommodated in the recesses 56. The outer surface of the lower end of the parison 16 is pushed by the parison outer holding plate 52 to move towards the airtight guide tube 54. As a result, the lower end of the parison 16 is held between the parison outer holding plate 52 and the airtight guide tube 54. The parison expanders 50 become integral with the airtight guide tube 54 to hold the inner surface of the lower end of the parison 16. And the lower end of the airtight guide tube 54 is closed with the lower guide plate 68 to make the lower end of the parison 16 airtight.

Next, as shown in FIGS. 8 through 10, the preblowing process is carried out. The preblowing process can be performed by blowing gas into the parison 16 from ends of the parison expanders 50 to inflate the parison 16. As shown in FIG. 10, the preblowing outlet ports 64 are provided at ends of the parison expanders 50. Gas can be blown into the parison 16 from the preblowing outlet ports 64. In the present embodiment, the gas adapted to be blown into the parison 16 is composed of air.

At this time, the upper end of the parison 16 is closed with the upper pinching plate 80, whereas the lower end of the parison 16 is closed with the airtight guide tube 54 and the parison expanders 50 to prevent leakage of air. And the lower end of the airtight guide tube 54 is closed with the lower guide plate 68 to prevent leakage of air.

As shown in FIG. 9, the parison expanders 50 are slid with parison cylinders 82.

Next, as shown in FIG. 11, the built-in part holding rod 66 holding the build-in part 42 is slid upwardly from the airtight guide tube 54 into the interior space of the parison 16 inflated by preblowing, and as a result, the built-in part 42 is positioned in the cavity 68 of the blow mold 44. At this time, the parison 16 is inflated by preblowing so that the built-in part 42 does not contact the inner surface of the parison 16.

And, as shown in FIG. 12, the blow mold 44 is slightly closed, and a plurality of slide cores 70 provided in the blow mold 44 are slid. Since the slide cores 70 are provided in the positions facing the built-in part 42, the parison 16 can be pushed with the built-in part 42 and the slide cores 64 while being sandwiched therebetween.

At this time, the lower guide plate 68 is located at the upper end of the airtight guide tube to prevent leakage of air from the interior space of the parison 16.

Since the inner surface of the parison 16 is still in a molten state, the parison 16 can be fused to ends of the built-in part 42. At this time, the built-in part 42 is held with the built-in part holding rod 66 and the slide cores 70 so that the built-in part 42 can be securely attached to a prescribed position of the inner surface of the outer wall of the fuel tank 30.

Then, as shown in FIG. 13, the built-in part holding rod 66 is lowered with the built-in part 42 held with the slide cores 70, and is removed from the blow mold 42. Since the built-in part 42 is held with the slide cores 70, the built-in part 42 can be located in a prescribed position. At this time, the lower end of the parison 16 is held and sealed with the parison outer holding plate 52 of the parison holding unit 46, and the lower guide plate 68 is located at the lower end of the airtight guide tube 54 to seal the same so that air is prevented from leaking from the interior space of the parison 16.

Next, as shown in FIG. 14, the blow mold 44 is closed completely. As a result, a forward end and a rear end of the parison 16 are closed completely with the blow mold 44.

The forward end and the rear end of the parison 16 can be closed by bringing the upper mating faces 72 and the lower mating faces 76 of the blow mold 44 into close contact with each other. Alternatively, by providing such pinching plates as referred in the prior art between the blow mold 44 and the parison holding unit 46, the upper part or the lower part of the parison 16 may be closed.

Then, the ends of the parison 16 are cut by a slide cutter (not shown) provided on the upper and lower sides of the blow mold 44. And air is blown from air nozzles 84 into the interior space of the parison 16 to press the outer surface of the parison 16 against the inner surface of the blow mold 44, which defines a cavity 60, and consequently, the fuel tank 30 is configured.

At this time, a tip face of each of the slide cores 70 can become flush with an inner surface defining the cavity 60 of the blow mold 44. Next, air is further blown from the air nozzle 84 into the interior space of the parison 16 to press the outer surface of the parison 16 against the blow mold 44 completely. As a result, the fuel tank 30 can be configured completely. And air is circulated in the interior space of the parison 16 to complete blow molding. Thereafter, the blow mold 44 is opened to remove the fuel tank 30 therefrom.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A blow molding device for forming a blow molded article having a built-in part in an interior space thereof, comprising:
a blow mold adapted to form an outer wall of the blow molded article;
a parison holding unit adapted to hold a lower end of a parison; and
a built-in part holding unit adapted to hold the built-in part prior to blow molding, wherein
said blow mold includes two mold members split along a parting line thereof, said two mold members define a cavity adapted to form the outer wall of the blow molded article in split faces thereof, slide cores are provided in an inner surface of said blow mold so as to be slid inwardly and outwardly of said cavity such that the built-in part and the parison are held between said slide cores, and the outer wall of the blow molded article is molded with said cavity,
said parison holding unit is located on the lower side of said blow mold, and includes a plurality of parison expanders adapted to be inserted in an interior space of a lower end of the parison, and a parison outer holding plate adapted to hold an outer surface of the lower end of the parison, each of said parison expanders is attached so as to slide outwardly from a center of the parison,
said built-in part holding unit includes an airtight guide tube adapted to hold the built-in part therein, a holding rod adapted to hold the built-in part in said airtight guide tube so as to slide the built-in part upwardly and downwardly, and a lower guide plate having a hole through which said holding rod is slidable,
said blow molding device is arranged such that when said blow mold is opened, the lower end of the parison located in said cavity of said blow mold that is opened is expanded with said plurality of parison expanders, after said airtight guide tube is inserted in the lower end of the parison, the lower end of the parison is held between said airtight guide tube and said parison outer holding plate, the parison is inflated to carry out preblowing, the built-in part is slid from said airtight guide tube to the interior space of the parison with said holding rod so as to hold the built-in part in a position facing said cavity, when said blow mold is closed, the built-in part is positioned in the interior space of the parison, and after the parison and the built-in part are held between said slide cores, said holding rod is removed from said blow mold.

2. The blow molding device as claimed in claim 1, further comprising preblow injection ports at upper ends of said parison expanders so as to inject gas when an upper end of said airtight guide tube and said parison outer holding plate hold the lower end of the parison.

3. The blow molding device as claimed in claim 1, wherein said parison expanders are arranged so as to contact said upper end of said airtight guide tube with a slide mechanism, and recesses adapted to accommodate ends of said parison expanders are formed in an upper end of said airtight guide tube.

4. The blow molding device as claimed in claim 1, further comprising an upper pinching plate adapted to pinch an upper end of the parison on the upper side of said blow mold away therefrom.

5. The blow molding device as claimed in claim 1, wherein said parison outer holding plate is split into two split plates so as to be respectively moved by a cylinder toward an end face of said airtight guide tube to contact the same.

6. A blow molding method for forming a blow molded article having a built-in part in an interior space thereof, wherein said blow molding method uses a blow mold adapted to form an outer wall of the blow molded article, a parison holding unit adapted to hold a lower end of a parison, and a built-in part holding unit adapted to hold the built-in part prior to blow molding, wherein
said blow mold includes two mold members split along a parting line thereof, said two mold members define a cavity adapted to form the outer wall of the blow molded article in split faces thereof, slide cores are provided in an inner surface of said blow mold so as to be slid inwardly and outwardly of said cavity such that the built-in part and the parison are held between said slide cores, and the outer wall of the blow molded article is molded with said cavity,
said parison holding unit is located on the lower side of said blow mold, and includes a plurality of parison expanders adapted to be inserted in an interior space of a lower end of the parison, and a parison outer holding plate adapted to hold an outer surface of the lower end of the parison, each of said parison expanders is attached so as to slide outwardly from a center of the parison,
said built-in part holding unit includes an airtight guide tube adapted to hold the built-in part therein, a holding rod adapted to hold the built-in part in said airtight guide tube so as to slide the built-in part upwardly and downwardly, and a lower guide plate having a hole through which said holding rod is slidable, and
said blow mold is opened along said parting line, the parison is dropped in said cavity that is opened, after the lower end of the parison is expanded with said plurality of parison expanders, said airtight guide tube is inserted in the lower end of said parison, the lower end of the parison is held between said airtight guide tube and said parison outer holding plate, and gas is inserted in the interior space of the parison to inflate the same, thereby carrying out preblowing, and the built-in part is positioned in the interior space of the parison from said airtight guide tube while holding the built-in part with said holding rod, and is held in a position facing said cavity, when said blow mold is closed, and the parison and the built-in part are held between said slide cores, said holding rod is removed from said blow mold, said blow mold is closed completely and gas is blown in the interior space of said parison, thereby forming said blow molded article.

7. The blow molding method as claimed in claim 6, wherein said preblowing is carried out by injecting gas from preblow injection ports provided at upper ends of said parison expanders after an upper end of said airtight guide tube and said parison outer holding plate hold the lower end of the parison.

8. The blow molding method as claimed in claim 6, wherein recesses adapted to accommodate ends of said parison expanders are formed in an upper end of said airtight guide tube, after said parison expanders are accommodated in said recesses of said airtight guide tube with a slide mechanism, said upper end of said airtight guide tube and said parison expanders contact an inner surface of the parison, whereas said outer holding plate contacts an outer surface of the parison, thereby holding an outside of the lower end of the parison.

9. The blow molding method as claimed in claim 6, wherein prior to preblowing, an upper end of the parison is pinched with an upper pinching plate provided on the upper side of said blow mold away therefrom.

10. The blow molding method as claimed in claim 6, wherein said parison outer holding plate is split into two split plates so as to be respectively moved by a cylinder toward an end face of said airtight guide tube to contact the same.
